(19) United States
(12) Patent Application Publication
(10) Pub. No.: US 2025/0319916 A1
(43) Pub. Date: Oct. 16, 2025

(54) FOLDABLE STROLLER

(71) Applicant: WonderFold Corporation, Irwindale, CA (US)

(72) Inventors: Tang Ming, Dongguan City (CN); Wei Jun, Dongguan City (CN); Wu Dashuai, Dongguan City (CN)

(21) Appl. No.: 19/220,796

(22) Filed: May 28, 2025

(30) Foreign Application Priority Data
Apr. 12, 2024 (CN) 202420761462.4

(51) Int. Cl. B62B 3/02; A01K 1/02; B62B 5/00; B62B 5/06; B62B 9/14

(52) U.S. Cl. CPC B62B 3/022; B62B 5/0013; B62B 5/067; A01K 1/0236; B62B 9/142

(57) ABSTRACT

A foldable vehicle or stroller is provided. The apparatus includes a bottom bracket forming a vehicle base, a push rod bracket rotatably connected to the bottom bracket, and a protective assembly located on one side of the push rod bracket between the push rod bracket and the bottom bracket. The foldable vehicle is in an unfolded state, remote ends of the push rod bracket and the bottom bracket are positioned apart, proximal ends of the push rod bracket and the bottom bracket join at a rotation element, and an accommodating space is formed between the bottom bracket, the protective assembly and the push rod bracket. When the foldable vehicle is in a folded state, remote ends of the push rod bracket and the bottom bracket are positioned proximally and the protective assembly is positioned at least partially between the push rod bracket and the bottom bracket.

The present application claims priority based on Chinese Utility Model Patent Application No. 202420761462.4, filing date Apr. 12, 2024, entitled “Vehicle,” inventors Tang Ming and Wei Jun, the entirety of which is incorporated herein by reference.

### BACKGROUND

### I. Field

The present invention relates generally to the field of vehicles and in particular to a vehicle useful in transporting pets and potentially other relatively small items.

### II. Background

Certain vehicles have protective components to block sunlight, rain, or snow. Users desire a compact form that can be, for example, transported in the trunk of an automobile. Employing protective components can make the structure of the vehicle complicated, inhibiting folding of the vehicle. In prior designs, the protective components must be removed and potentially stored before the vehicle can be folded. Some vehicles can be folded together with the protective components. However, such vehicles can be large in size after folding, which will occupy a large space and is not convenient for storage.

A number of strollers and wagons are available for transporting various items, including people and various inanimate objects. However, smaller vehicles can be useful in that they can be folded and stored in smaller spaces while still accommodating certain desired items, typically smaller in size.

It would therefore be beneficial to provide a vehicle, such as a stroller or wagon type device, that can be folded into a smaller configuration than previously available while offering sturdiness when unfolded and an ability to carry certain desired relatively small items.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

According to one embodiment, there is provided a foldable vehicle or stroller is provided. The apparatus includes a bottom bracket forming a vehicle base, a push rod bracket rotatably connected to the bottom bracket, and a protective assembly located on one side of the push rod bracket between the push rod bracket and the bottom bracket. The foldable vehicle is in an unfolded state, remote ends of the push rod bracket and the bottom bracket are positioned apart, proximal ends of the push rod bracket and the bottom bracket join at a rotation element, and an accommodating space is formed between the bottom bracket, the protective assembly and the push rod bracket. When the foldable vehicle is in a folded state, remote ends of the push rod bracket and the bottom bracket are positioned proximally and the protective assembly is positioned at least partially between the push rod bracket and the bottom bracket.

According to another embodiment, there is provided a foldable vehicle comprising a vehicle base attached to a set of wheels, a push rod assembly rotatably connected to the vehicle base, and a protective assembly positioned proximate to and between the push rod assembly and the vehicle base. When the foldable vehicle is in an unfolded state, remote ends of the vehicle base and the push rod assembly are positioned apart, proximal ends of the vehicle base and the push rod assembly join at a rotation element, and an accommodating space is formed between the vehicle base, the push rod assembly connected to the vehicle base, and the protective assembly.

According to a further embodiment, there is provided a foldable vehicle comprising a vehicle base attached to a set of wheels, a push rod assembly rotatably connected to the vehicle base, and a protective covering assembly connected to the vehicle base and the push rod assembly. When the foldable vehicle is in an unfolded state, remote ends of the vehicle base and the push rod assembly are positioned apart, proximal ends of the vehicle base and the push rod assembly join at a rotation element, and an accommodating space is formed between the vehicle base, the push rod assembly, and the protective covering assembly.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a schematic diagram of the three-dimensional structure of a carrier or vehicle of a specific embodiment of the present design in an unfolded state;

FIG. 2 is a schematic diagram of FIG. 1 with a first opening portion opened;

FIG. 3 is a rear view of FIG. 1;

FIG. 4 is a schematic diagram of FIG. 3 when a second opening portion is opened;

FIG. 5 is a schematic diagram of the carrier of FIG. 1 during folding, wherein the first protective member and the second protective member are hidden;

FIG. 6 is a schematic diagram of the three-dimensional structure of the carrier of FIG. 5 when the push rod frame and the bottom frame are folded together;

FIG. 7 is a side view of FIG. 6;

FIG. 8 is a side view of the carrier of FIG. 6 in the folded state;

FIG. 9 is a bottom view of FIG. 8;

FIG. 10 is a schematic diagram of the three-dimensional structure of the bottom bracket and wheel assembly of the carrier of this embodiment;

FIG. 11 is a schematic diagram of the exploded structure of part of FIG. 10;

FIG. 12 is a schematic diagram of FIG. 10 during the folding process;

FIG. 13 is a schematic diagram of FIG. 10 in a folded state;

FIG. 14 is a top perspective view showing the front, right, and rear sides of a first pet stroller or foldable vehicle embodiment (three panel) according to the present design;

FIG. 15 is a right side elevation view of the first embodiment of the pet stroller;

FIG. 16 is a left side elevation view of the first embodiment of the pet stroller;

FIG. 17 is a front elevation view of the first embodiment of the pet stroller;

FIG. 18 is a rear elevation view of the first embodiment of the pet stroller;

FIG. 19 is a top plan view of the first embodiment of the pet stroller;

FIG. 20 is a bottom plan view of the first embodiment of the pet stroller;

FIG. 21 is a top perspective view showing the front, right, and rear sides of a second pet stroller or foldable vehicle embodiment (four panel) according to the present design;

FIG. 22 is a right side elevation view of the second embodiment of the pet stroller;

FIG. 23 is a left side elevation view of the second embodiment of the pet stroller;

FIG. 24 is a front elevation view of the second embodiment of the pet stroller;

FIG. 25 is a rear elevation view of the second embodiment of the pet stroller;

FIG. 26 is a top plan view of the second embodiment of the pet stroller;

FIG. 27 is a bottom plan view of the second embodiment of the pet stroller; and

FIG. 28 is a perspective drawing of the first and second embodiments of the pet stroller in a folded configuration.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

The present design includes, in one embodiment, a carrier having an unfolded state and a relatively small folded state. The carrier includes a bottom bracket, a push rod frame, and a protective assembly. The push rod frame is rotatably connected to the bottom bracket, the protective assembly is located on one side of the push rod frame, and the protective assembly is arranged between the push rod frame and the bottom bracket,

When the carrier is in the unfolded state, the push rod frame and the bottom bracket are relatively unfolded, and an accommodating space is formed between the bottom bracket, the protective assembly, and the push rod frame. When the carrier is in the folded state, the push rod frame and the bottom bracket are relatively folded, and the protective assembly is folded between the push rod frame and the bottom bracket.

Further, the first protective member is provided with a first opening that can communicate with the accommodating space, and a sealing structure that can control the opening and closing of the first opening.

The sealing structure of the design may comprise Velcro, straps, buttons, and/or zipper components. The protective component also includes a shade flexible cover, the shade flexible cover is arranged on the first protective member,

The first protective member is provided with a receiving cavity. The shade flexible cover has at least a first state and a second state. When the shade flexible cover is in the first state, the shade flexible cover resides in the receiving cavity. When the shade flexible cover is in the second state, the shade flexible cover at least covers part of the outer surface of the first protective member.

The second protective member may include a main body, the main body fixedly arranged on the push rod frame and fixedly connected to the first protective member. The main body may be provided with a second opening that communicates with the accommodating space. The second protective member may also include a shielding member for shielding the second opening, and a connecting structure between the shielding member and the main body to achieve a detachable connection between the two.

In some embodiments, the push rod frame includes a first push rod frame and a second push rod frame. One end of the second push rod frame may be rotatably connected to the bottom bracket around a first rotation center line. The other end of the second push rod frame may be rotatably connected to the first push rod frame around a second rotation center line. In one embodiment, the first rotation center line and the second rotation center line are parallel to each other.

When the carrier is in the unfolded state, the first push rod frame and the second push rod frame extend along the same length direction, and when the carrier is in the folded state, the first push rod frame, the second push rod frame, the protective assembly, and the bottom bracket may be folded in sequence. When the carrier is in the unfolded state, the projections of the push rod frame and the bottom bracket in the vertical plane form an obtuse angle.

The carrier may also include a wheel assembly including a wheel frame and a wheel body rotatably connected to the wheel frame around a wheel axle. The wheel frame can be rotatably connected to the bottom bracket around a rotation center line extending in a first direction. When the carrier is in the unfolded state, the wheel axle extends in the horizontal direction. When the carrier is in the folded state, the wheel body may be folded relative to the bottom bracket with the wheel axle extending in an up and down direction.

The base frame may include a bottom support rod extending along the first direction. The wheel frame may include a connecting rod extending along the first direction. The bottom support rod may have a hollow rod cavity extending along the first direction. The connecting rod may be inserted into the hollow rod cavity. The axis of the connecting rod may extend colinearly with the rotation centerline.

Such a carrier or vehicle provides a protective component arranged on one side of the push rod frame. When the carrier is folded, the push rod frame is folded relative to the bottom bracket, and the protective component can be folded together with the push rod frame and the bottom bracket. When the carrier is in the folded state, the protective component may be folded between the push rod frame and the bottom bracket, thereby reducing the space occupied by the carrier and facilitating storage and arrangement.

The following is a listing of the elements provided in the drawings: 100, bottom bracket; 110, bottom support rod; 111, matching piece; 120, horizontal support rod; 130, bottom plate; 200, push rod frame; 210, first push rod frame; 211, push handle rod; 212, first push rod; 220, second push rod frame; 221, second push rod; 222, second mounting rod; 223, locking piece; 300, wheel assembly; 310, wheel frame; 311, connecting rod; 312, wheel seat; 320, wheel body; 400, protective assembly; 410, support frame; 420, first protection member; 421, first opening; 422, sealing structure; 423, light-transmitting portion; 430, second protection member; 431, main body; 432, second opening; 433, shielding member; 434, connecting structure; 435, storage bag.

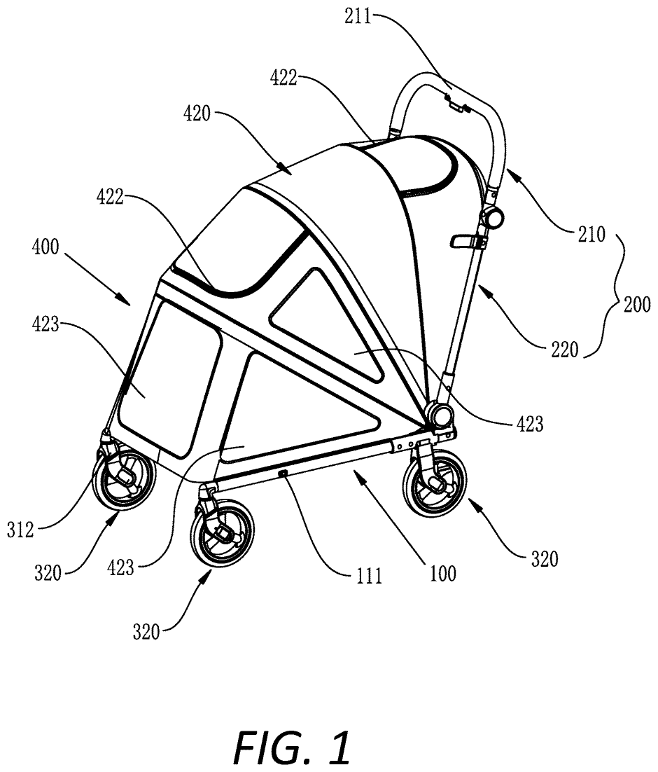

The carrier or vehicle shown in FIGS. 1 to 4, has an unfolded state and a folded state. The carrier includes a bottom bracket 100, a push rod frame 200, and a protective assembly 400, wherein the push rod frame 200 is rotatably connected to the bottom bracket 100, the protective assembly 400 is located on one side of the push rod frame 200, and the protective assembly 400 is arranged between the push rod frame 200 and the bottom bracket 100. When the carrier is in the unfolded state, the push rod frame 200 and the bottom bracket 100 are relatively unfolded, and an accommodating space is formed between the bottom bracket 100, the protective assembly 400, and the push rod frame 200. When the carrier is in the folded state, the push rod frame 200 and the bottom bracket 100 are relatively folded, and the protective assembly 400 is folded between the push rod frame 200 and the bottom bracket 100.

The carrier can be an ordinary cart for transporting goods, a child cart for carrying children, or a pet cart for carrying pets, or any combination of such items where practical. In the unfolded state, children or pets can sit in the storage space, and/or the user can place goods in the storage space. In this state, the protective assembly 400 can prevent third parties from reaching into the accommodating space, and the protective assembly 400 can also prevent children and items maintained from falling from the carrier, or prevent pets in the storage space from escaping. When the carrier is folded, the protective assembly 400 can also be folded together with the push rod frame 200 and the bottom bracket 100.

In order to more clearly describe the relative positional relationship of each component on the carrier, the upper, lower, left, right, front, back, inside, and outside directions are defined by the direction observed when the carrier is in the unfolded state.

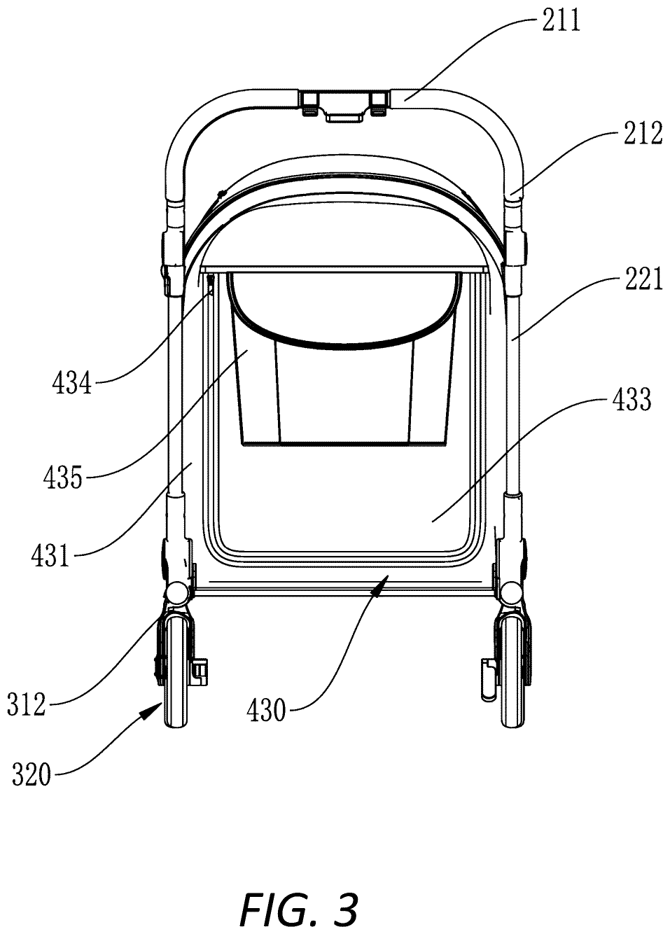

In this embodiment, referring to FIGS. 1 to 5, the protective assembly 400 includes a support frame 410, a first protection member 420, and a second protection member 430. The support frame 410 supports the first protection member 420. The support frame 410 is disposed between the push rod frame 200 and the bottom bracket 100, and the support frame 410 is rotatably connected to push rod frame 200, or support frame 410 is rotatably connected to the bottom bracket 100. The first protection member 420 fits over support frame 410, and the first protection member 420 is disposed between the push rod frame 200, the support frame 410 and the bottom bracket 100. The second protection member 430 is disposed on the push rod frame 200 and may be fixedly connected to the first protection member 420. When the carrier is in the unfolded state, an accommodation space is formed between the first protection member 420, the second protection member 430 and the bottom bracket 100. As shown in FIGS. 1 and 3, the second protective member 430 may be located at the rear side of the accommodating space, the bottom bracket 100 below the accommodating space, and the first protective member 420 is arranged around the front, top, left and right sides of the accommodating space, thereby forming a protective region for the items, children, and/or pets in the accommodating space.

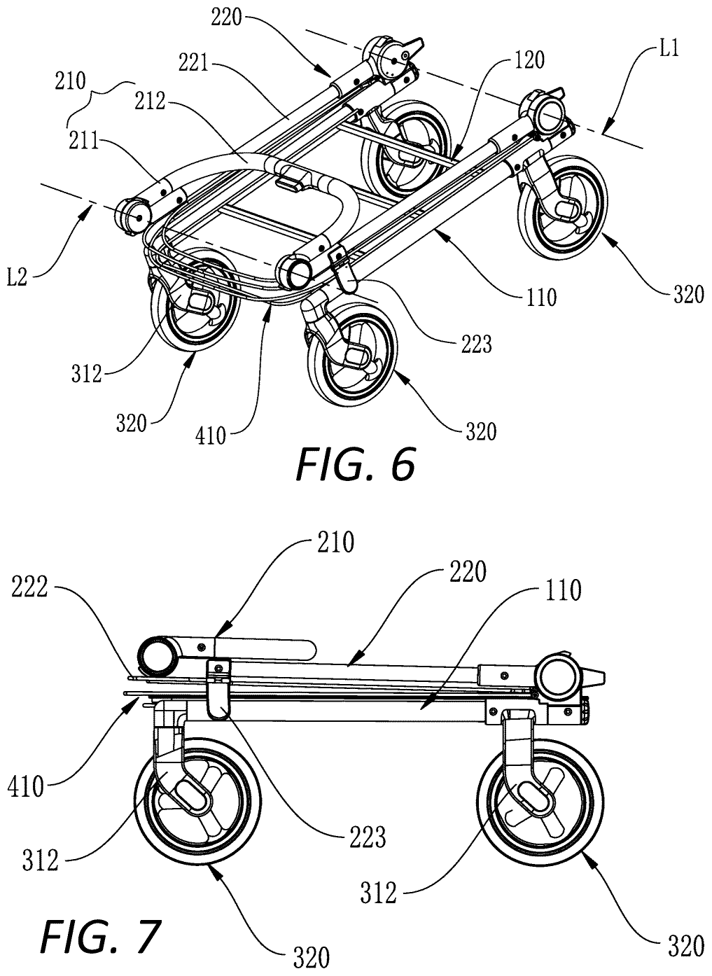

In this embodiment, three groups of support frames 410 are provided, and the three groups of support frames 410 are rotatably connected to the lower part of the push rod frame 200. The support frames 410 can rotate in the forward and rearward directions when the carrier is in the unfolded state. The three groups of support frames 410 are generally distributed at intervals, and the three groups of support frames 410 divide the first protective member 420 into four parts connected to each other in this embodiment. More or fewer parts may be employed, with a correspondingly appropriate number of other elements such as support frames 410. When the carrier is in a folded state, in this embodiment, the three groups of support frames 410 are typically folded above the bottom bracket 100. Specifically, as shown in FIG. 6, the support frame 410 is U-shaped, the push rod frame 200 includes two push rods arranged on both sides, and the two free ends of the support frame 410 are respectively rotatably connected to the lower parts of the two push rods. The first protective member 420 is sleeved on the outside of the support frame 410 and connected to the support frame 410. In the process of folding the support frame 410 relative to the bottom bracket 100, the first protective member 420 is also folded relative to the bottom bracket 100. In other embodiments, the support frame 410 may be provided with only one group, or any number of groups other than three.

In this embodiment, one end of the first protective member 420 is fixedly connected to the bottom bracket 100. The other end of the first protective member 420 is connected to the second protective member 430. The second protective member 430 is fixedly connected to the push rod. The first protective member 420 and the second protective member 430 are integrated with one another in the design. When the foldable vehicle is in the folded state, the push rod frame 200 may be folded relative to the bottom bracket 100. The second protective member 430 and the first protective member 420 may be folded together and both may be folded relative to the bottom bracket 100.

In this embodiment, the bottom bracket 100 and the push rod frame 200 are provided with a first mounting rod and a second mounting rod 222, respectively, for fixing the protective assembly 400. The first mounting rod and the second mounting rod 222 are both U-shaped. When the foldable vehicle is in the unfolded state, the first mounting rod is arranged at the front of the bottom bracket 100 and the opening faces backward, and the second mounting rod 222 is arranged at the upper part of the push rod frame 200 such that the opening faces downward. When installing the integrally arranged first protective member 420 and the second protective member 430, one end of the first protective member 420 may be fixed on the first mounting rod and fixed to the bottom bracket 100. The second protective member 430 may be sleeved on the second mounting rod and fixed to the two push rods on both sides.

In this embodiment, when the foldable vehicle is in the unfolded state, the projections of the push rod frame 200 and the bottom bracket 100 in the vertical plane are at an obtuse angle, and the periphery of the first protective member 420 is in an arc shape that bends upward from the front to the back. Such a configuration provides a relatively large volume of accommodating space.

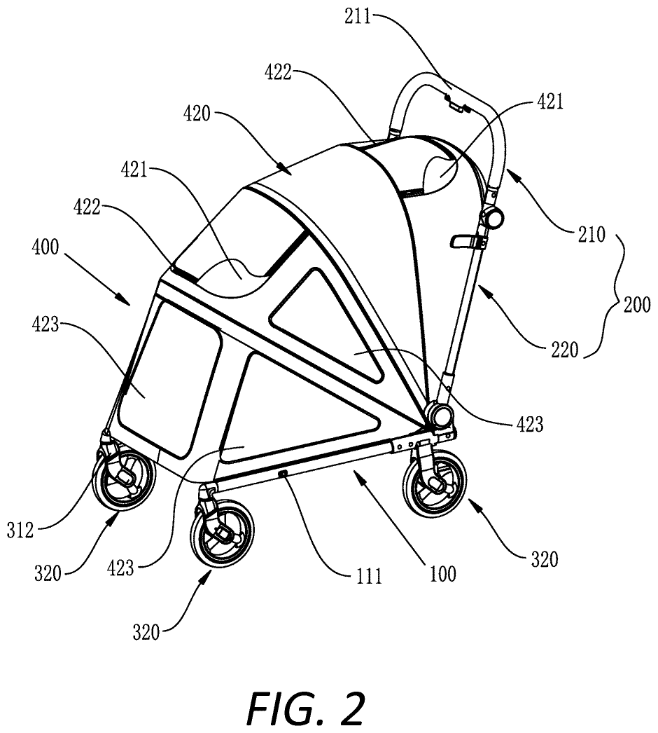

In this embodiment, the first protective member 420 has a first opening 421 provided above the accommodating space and a sealing structure 422 that can be used to control opening and closing of first opening 421. The sealing structure 422 can be one of nylon hook and loop, straps, buttons and zipper components, as well as other viable closure components. In this embodiment, as shown in FIG. 2, two first openings 421 may be provided on the first protective member 420, one of which, the lower first opening, is arranged at the front of the first protective member 420. The other first opening 421, the upper first opening, may be provided at the upper part of first protective member 420. In the case of two first openings 421, each is provided at a different position to allow opening and closing and access to the accommodating space. The lower first opening located is lower than the upper first opening. The sealing structure 422 is a zipper component in one embodiment. The opening and closing of the two first openings 421 are controlled by one or more closure devices, such as a zipper or zippers. The carrier of this embodiment is suitable for use as a pet stroller. When the carrier is in motion, an appropriate sized pet can be placed through first opening 421. A pet may stick its head out of first opening 421. The two first openings 421, one in front and one in the back, one high and one low, can potentially accommodate pets of different sizes and offer different pet viewing angles.

In this embodiment, the first protective member 420 may be made of a flexible material such as a cloth. The first protective member 420 may be provided with a light-transmitting portion similar to light transmitting portion 423 in FIG. 1, and that light-transmitting portion may be provided with many openings or holes. The protective assembly 400 also includes a shading flexible cover made of a flexible material. The shading flexible cover may be set on the first protective member 420 to block sunlight for the pet when the sunlight is strong and the light transmitting portion is provided in first protective member 420. In some embodiments, the shading flexible cover can also be used to block wind and rain. In other embodiments, a light-transmitting portion may not be provided on the first protective member 420, and the first protective member 420 can block sunlight, wind, and rain. In this arrangement, no shading flexible cover is needed on the first protective member 420.

The first protective member 420 may be provided with a receiving cavity (not shown in the figure) for receiving and storing a shade flexible cover. When there is no shading needed, the shade flexible cover may be stored in the receiving cavity. When the sunlight is strong, the shade flexible cover may cover part of the outer surface of the first protective member 420 to block the sunlight. In this embodiment, a fixing structure is provided between bottom bracket 100 and the shade flexible cover or between the first protective member 420 and the shade flexible cover, which is used to fix the shade flexible cover to maintain it in the second state. In this embodiment, the receiving cavity may be provided at the middle support frame 410. A joining mechanism, such as a zipper assembly, may be provided on the first protective member 420 to control opening and closing of the receiving cavity.

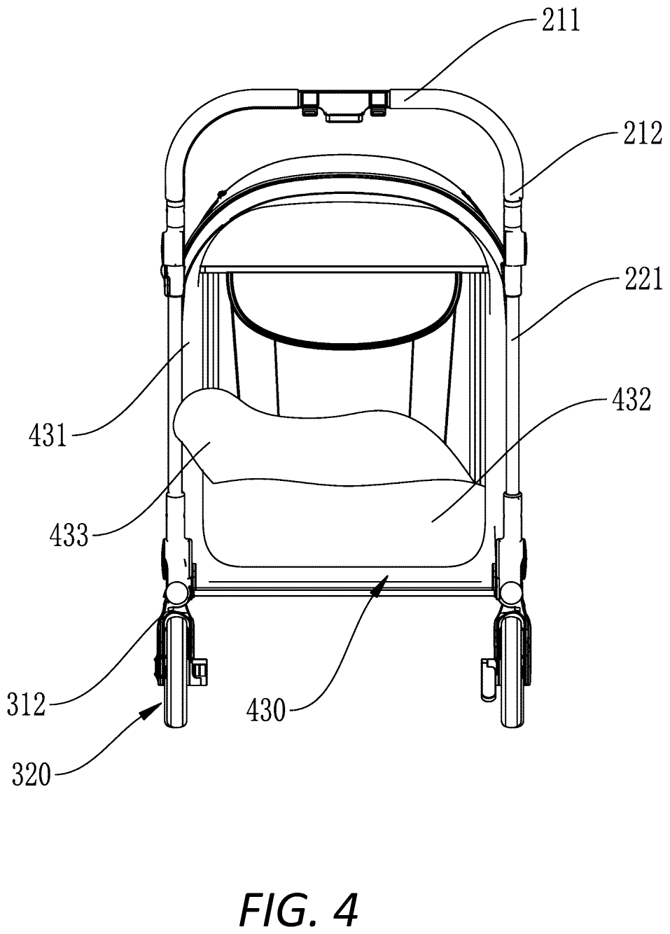

As shown in FIG. 4, the second protective member 430 includes a main body 431 attachable to push rod frame 200 and fixedly connected to first protective member 420. The main body 431 is provided with a second opening 432 connected to the accommodating space, and a pet, for example, can enter the accommodating space from the second opening 432. The second protective member 430 is also provided with a shielding member 433 for shielding the second opening 432. A connecting structure 434 for detachably connecting the shielding member 433 and the main body 431 is provided between the shielding member 433 and the main body 431. The connecting structure 434 may comprise one of a nylon buckle, a strap, a button, and a zipper or other appropriate joining mechanisms.

Second opening 432 is located at the rear side of the carrier, and the upper part of shielding member 433 may be fixedly connected to the main body 431. Shielding member 433 is lifted upward to open second opening 432. The lower part of shielding member 433 is detachably connected to main body 431 through, for example, a zipper assembly, but other connection devices may be provided such as a hook and loop arrangement. When second opening 432 is to be closed, shielding member 433 may be connected to the main body 431 through the zipper assembly. Main body 431 and shielding member 433 can be formed as a single piece, cut as a single cloth cove. Connecting structure 434 may be provided to control the opening and closing of the second opening 432.

Storage bag 435 may be provided on the shielding member 433. The user can place personal belongings in storage bag 435. The upper and side portions of the storage bag 435 in this embodiment are both provided with openings that interface with the interior. The storage bag 435 can be used to place desired items. Cleaning products can be placed in storage bag 435 from the upper opening and extracted from the side opening.

In this embodiment, the push rod frame 200 also includes push handle rod 211. In the unfolded state, the push rod extends in the up and down directions. The push handle rod 211 is connected between the upper portions of the two push rods 220 and 221, and the push handle rod 211 may be located above the second protective member 430. A fixing member (not shown in the figure) for connecting with the push handle rod 211 may be provided on the shielding member 433. When the fixing member is connected to the push handle rod 211, the second opening 432 can be maintained in an open state. The fixing member can take the form of a hook arranged at the lower part of shielding member 433. After the shielding member 433 is lifted upward, such a hook can attach to the push handle rod 211 so that second opening 432 remains open. Shielding member 433 can hang on push rod 211 through a fixing member such as a hook or other appropriate connecting mechanism.

FIG. 6 shows the advantageous compact folding arrangement provided with the present design. As shown in FIG. 6, the push rod frame 200 includes a first push rod frame 210 and a second push rod frame 220. One end of the second push rod frame 220 is connected to the bottom bracket 100 rotatably around the first rotation center line L1. The other end of the second push rod frame 220 is connected to the first push rod frame 210 rotatably around the second rotation center line L2. First rotation center line LI and second rotation center line L2 are parallel to each other. First rotation center line LI and second rotation center line L2 both extend in the left and right directions. When the carrier is in a folded state, the first push rod frame 210 and the second push rod frame 220 are folded relative to one another as shown, reducing the length of the push rod frame 200 in the folded state.

In this embodiment, the first push rod frame 210 includes two first push rods 212 disposed on the left and right sides and a push handle rod 211 extending in the left and right directions. The two first push rods 212 are integrally arranged with the push handle rod 211. When the vehicle or carrier is in the unfolded state, the first push rod frame 210 is in a U-shape with the opening facing downward. The second push rod frame 220 includes two second push rods 221 disposed on the left and right sides. One end of the second push rod 221 is rotatably connected to the bottom bracket 100 around the first rotation center line L1, and the other end of the second push rod 221 is rotatably connected to the first push rod 212 around the second rotation center line L2. In some embodiments, the first push rod 212 and the second push rod 221 constitute the above-mentioned push rods. In this embodiment, as shown in FIGS. 3 and 4, second protective member 430 is fixed on the second push rod frame 220, and second mounting rod 222 is disposed on the upper part of the second push rod frame 220.

Referring to FIGS. 7 to 13, the carrier further includes wheel assembly 300, which includes wheel frame 310 and wheel body 320 rotatably connected to wheel frame 310 around a wheel axle (not shown in the figure). Wheel frame 310 may be rotatably connected to bottom bracket 100 around a rotation center line L0 (FIG. 11) extending in a first direction. When the carrier is in an unfolded state, the wheel axle extends in a horizontal direction. When the carrier is in a folded state, wheel body 320 folds relative to bottom bracket 100, and the wheel axle extends in a vertical direction. Bottom bracket 100 includes wheel frame 310 and wheel body 320 rotatably connected to wheel frame 310 around a wheel axle (not shown). Wheel frame 310 is rotatably connected to bottom bracket 100 around rotation center line L0 extending in a first direction.

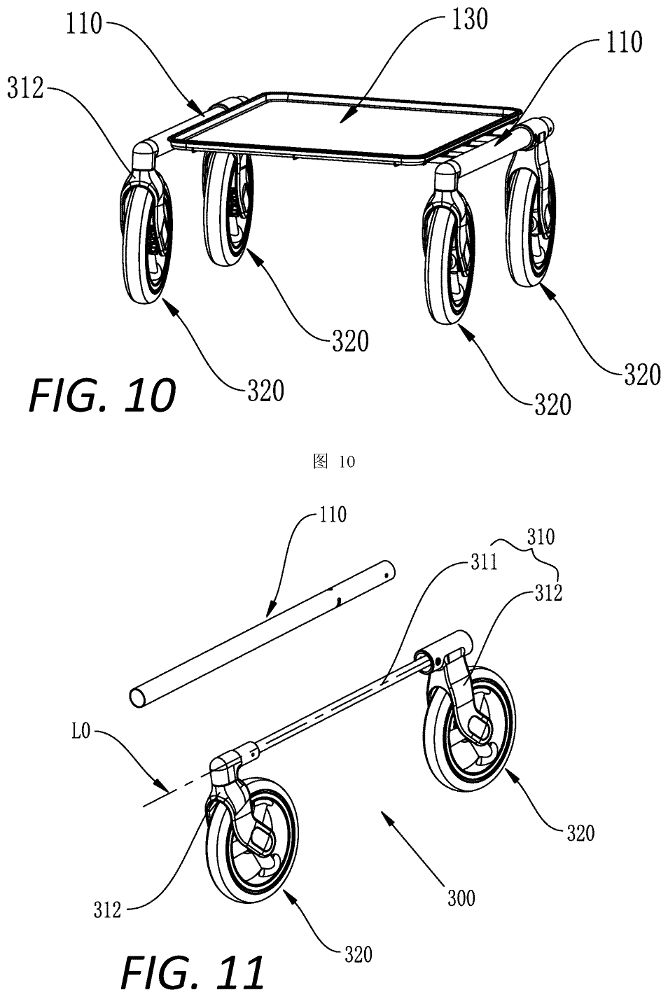

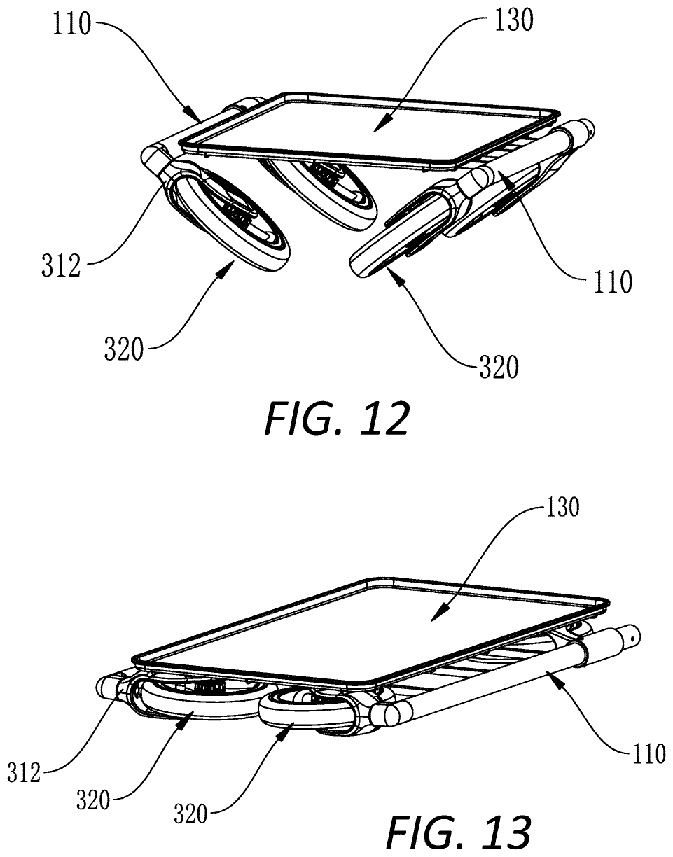

FIG. 11 is a schematic diagram of the exploded structure of part of FIG. 10, while FIG. 12 is a schematic diagram of FIG. 10 during the folding process and FIG. 13 is a schematic diagram of FIG. 10 in a folded state.

Referring to FIGS. 10 to 13, bottom support rod 110 extends in one direction and may have a hollow rod cavity extending in the first direction. Wheel frame 310 includes connecting rod 311 extending in the first direction. Connecting rod 311 is inserted in such a hollow rod cavity and the axis of connecting rod 311 extends colinearly with the rotation center line L0.

As shown in FIG. 6, bottom bracket 100 includes two bottom support rods 110 arranged on the left and right sides. Bottom support rod 110 and rotation center line L0 both extend in the front-to-back direction. Second push rod 221 is rotatably connected to the rear of bottom support rod 110 around first rotation center line L1. Wheel assembly 300 also includes two groups arranged on the left and right sides, and two wheel bodies 320 are arranged on each wheel frame 310. Connecting rod 311 extends in the front-to-back direction, and a wheel seat 312 is respectively provided at the front and rear of connecting rod 311. Two wheel bodies 320 are connected to wheel seat 312 rotatably around the wheel axle. In this embodiment, in the unfolded state, wheel seat 312 located at the front side is rotatably connected to connecting rod 311 around the vertical axis of rotation so that wheel body 320 located at the front side can be rotated. When the carrier is folded, wheel frame 310 rotates around the rotation center line L0 toward the bottom of bottom bracket 100, so that wheel body 320 folds under bottom bracket 100.

In some embodiments, a locking mechanism may be provided between the wheel frame 310 and the bottom bracket 100 to lock the carrier in the unfolded state. When the carrier is folded, the locking mechanism may be unlocked such that wheel frame 310 is manually driven to rotate and wheel body 320 folds below bottom bracket 100.

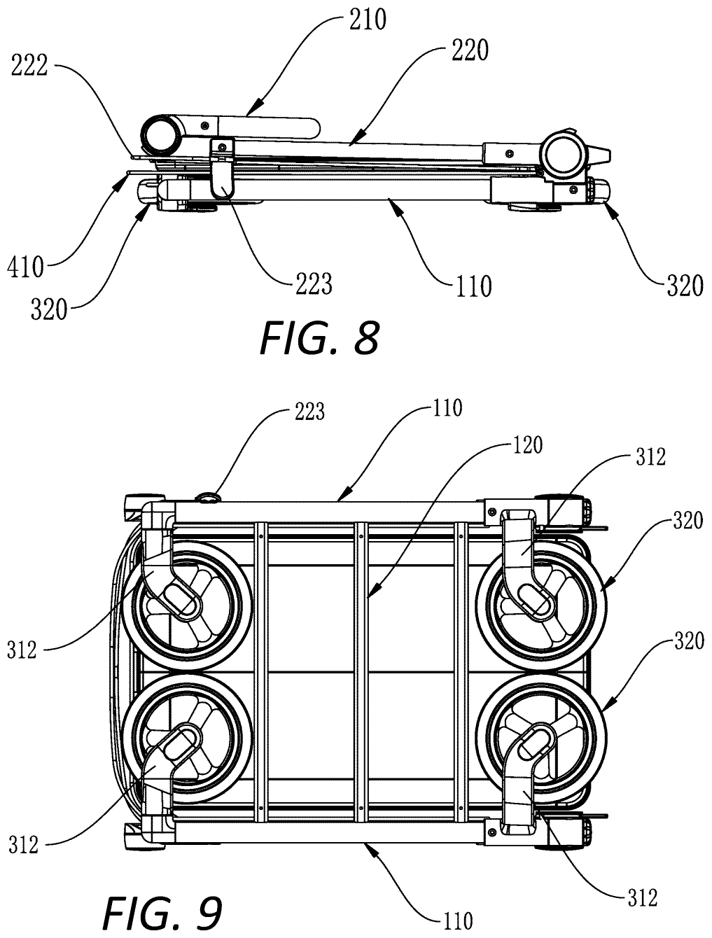

In other embodiments, a linkage assembly may be provided between push rod frame 200, bottom bracket 100, and wheel frame 310. In the process of folding the push rod frame 200 with bottom bracket 100, the linkage assembly can be linked to make wheel frame 310 rotate relative to bottom bracket 100 and complete the folding of wheel assembly 300. The linkage assembly includes a straight groove arranged at the rear of bottom support rod 110 and extending in the front-to-back direction, and a driving groove arranged at the rear of wheel frame 310. The driving groove may include a first groove extending in the front-to-back direction and a second groove extending backward and downward from the rear of the first groove. The linkage assembly also includes a linkage member, one end of the linkage member may be rotatably connected to the lower part of second push rod 221. The other end of the linkage member may be provided with a driving pin extending in the left-right direction. The driving pin may be inserted in the straight groove and the driving groove. In the unfolded state, the linkage member may be located at the front side of second push rod 221. The rotation connection between the linkage member and second push rod 221 is in front of the first rotation center line L1. In this state, the driving pin may be located in the front of the straight groove, and the driving pin located in the first groove. When push rod frame 200 folds toward bottom bracket 100, the linkage moves downward and backward. During this process, the driving pin moves backward along the straight groove, and the driving pin moves from the first groove to the second groove. In response to the movement of the driving pin and the second groove, wheel frame 310 rotates around the rotation center line LO such that wheel body 320 folds under bottom bracket 100. With this arrangement, when folding the carrier, it is only necessary to flip push rod frame 200 downward and the wheels, such as wheel 320, will retract into the configuration of FIGS. 8 and 9.

From FIGS. 9 and 10, bottom bracket 100 also includes cross support rod 120 and bottom plate 130 connected between two bottom support rods 110 to maintain the stability of bottom bracket 100. Three cross support rods are shown including cross support rod 120, and ore or fewer such rods may be provided. In the front-to-back direction, a plurality of cross support rods 120 may be arranged at intervals when three such rods or any other number are provided, the bottom plate 130 is in the accommodating space, and cross support rod 120 is supported below bottom plate 130.

In this embodiment, a locking assembly is provided between push rod frame 200 and bottom bracket 100. The locking assembly is configured to lock push rod frame 200 and bottom bracket 100 when the carrier is in a folded state. As shown in FIGS. 8 and 9, the locking assembly includes locking member 223 provided on second push rod frame 220. When the carrier is in an unfolded state, locking member 223 extends forward from the upper part of the second push rod 221. The locking assembly also includes matching member 111 provided on bottom support rod 110. When the carrier is in a folded state, locking member 223 is typically buckled and connected with matching member 111. In this embodiment, the locking assembly may be arranged on one side of the vehicle in the left-right direction. In other embodiments, the locking assembly may be arranged on both sides of the vehicle, so that the bottom bracket 100 and the push rod bracket 200 can be more firmly locked together in the folded state, providing stability when in the locked state.

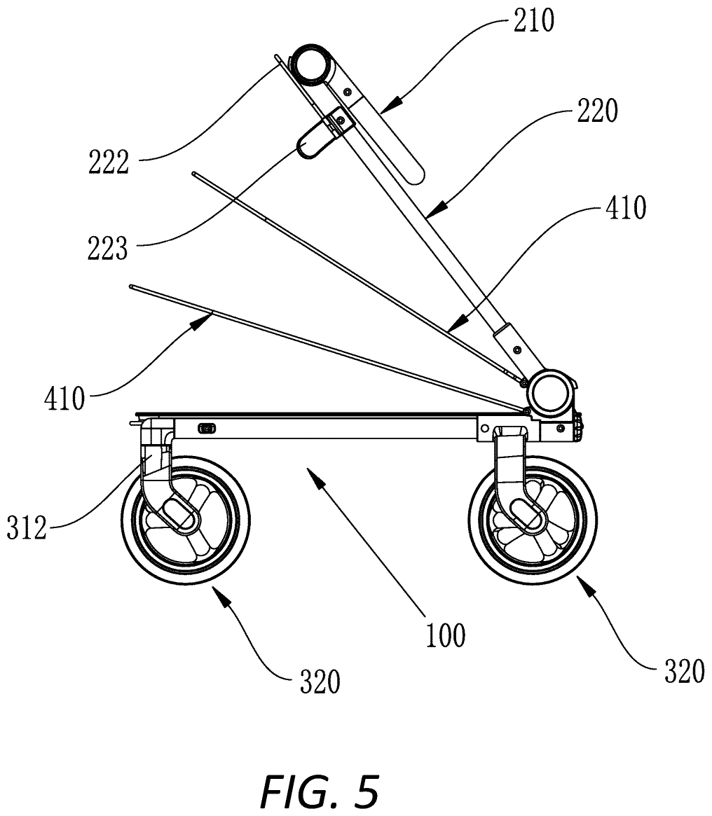

Thus the unfolded state of the vehicle or carrier of this embodiment as shown in FIG. 1 has push rod bracket 200 and bottom bracket 100 unfolded from one another. Protective assembly 400 is also relatively unfolded. First push rod bracket 210 and second push rod bracket 220 extend in the same length direction and the four wheels 320 are supported on the ground. The user can move the vehicle by pushing the push rod bracket 200. When the carrier is folded, as shown in FIGS. 5 to 9, first push rod frame 210 and second push rod frame 220 rotate and fold relative to each other, push rod frame 200 is turned downward to be folded relative to bottom bracket 100, and wheel frame 310 rotates so that wheel body 320 is folded below bottom bracket 100. During this process, protective component 400 can be folded relative to bottom bracket 100 along with push rod frame 200. In the folded state, as shown in FIGS. 8 and 9, first push rod frame 210, second push rod frame 220, protective component 400, bottom bracket 100, and wheel body 320 fold from top to bottom in sequence. The size of the folded carrier in the up and down direction, i.e., thickness, is greatly reduced. At the same time, the length in the front and back direction is roughly the same as the length of the bottom bracket 100. The space occupied by the carrier is relatively compact, convenient for storage.

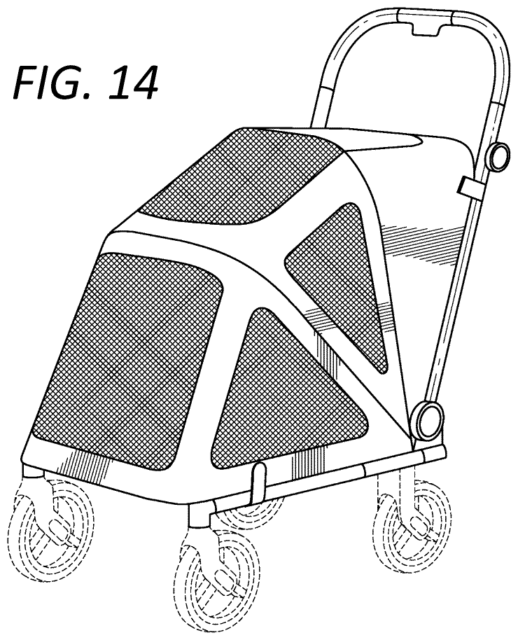

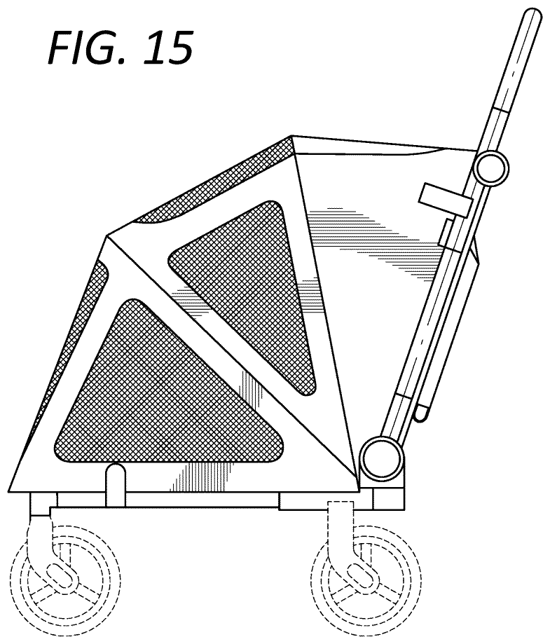

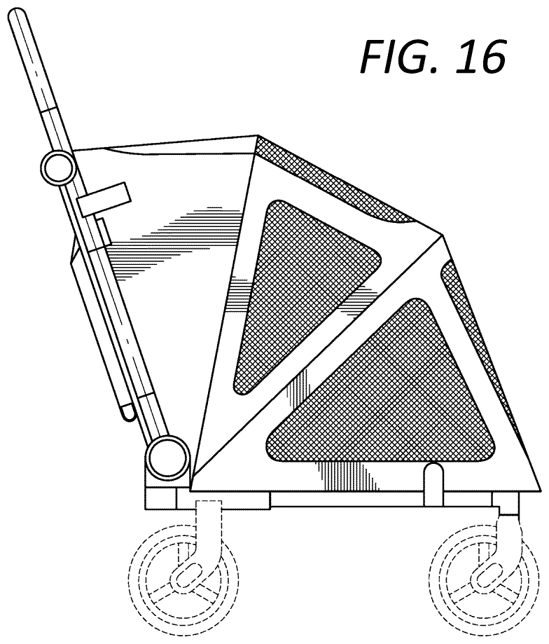

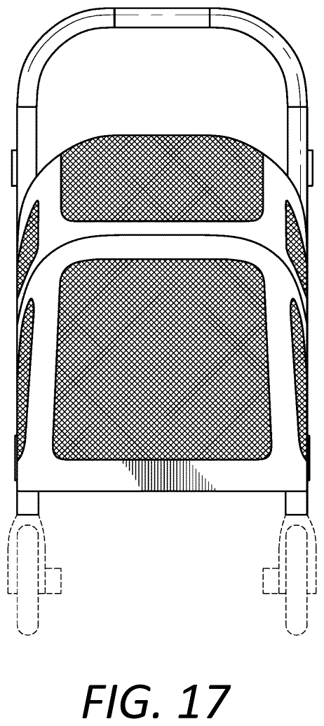

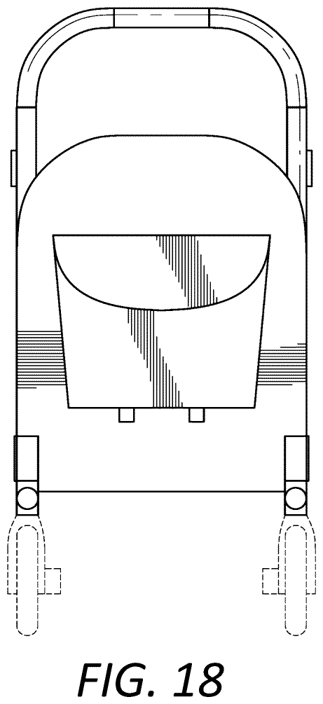

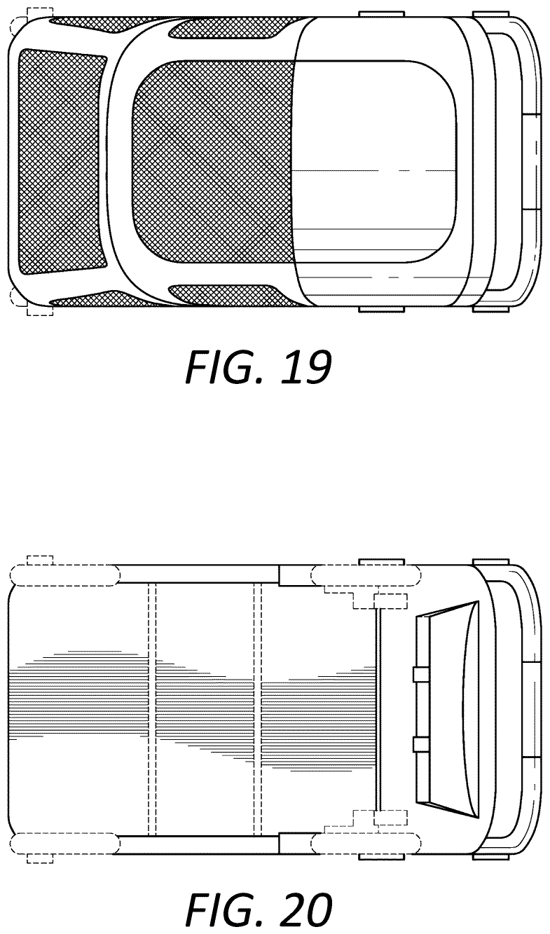

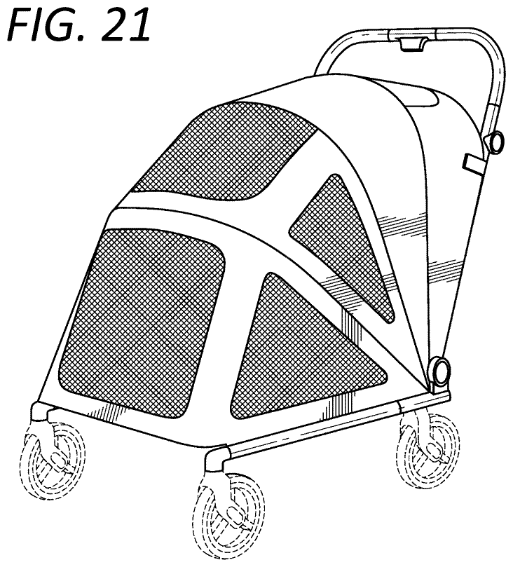

FIGS. 14-28 illustrate two embodiments of the current design, specifically a three panel and a four panel design. FIG. 14 is a top perspective view showing the front, right, and rear sides of a first pet stroller or foldable vehicle embodiment (three panel) according to the present design. FIG. 15 is a right side elevation view of the first embodiment, FIG. 16 a left side elevation view of the first embodiment, FIG. a front elevation view of the first embodiment, and FIG. 18 a rear elevation view of the first embodiment. FIG. 19 is a top plan view of the first embodiment while FIG. 20 is a bottom plan view of the first embodiment.

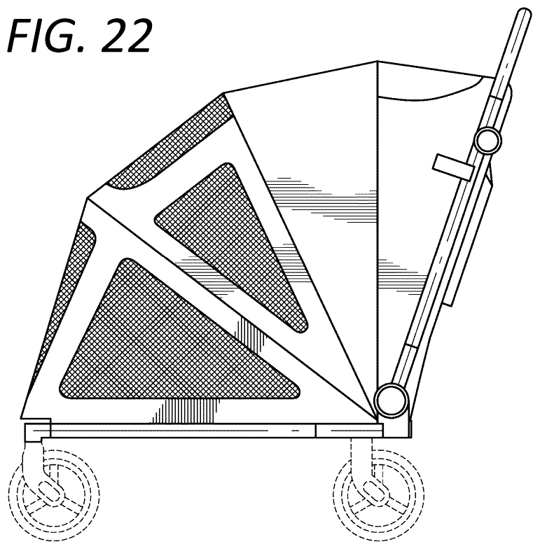

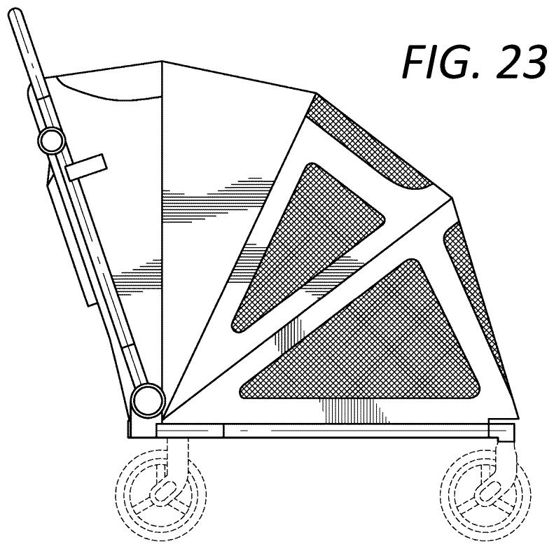

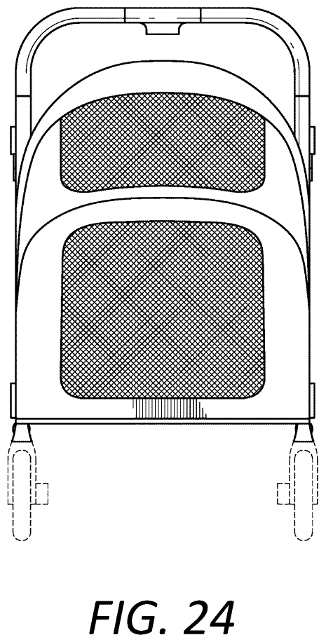

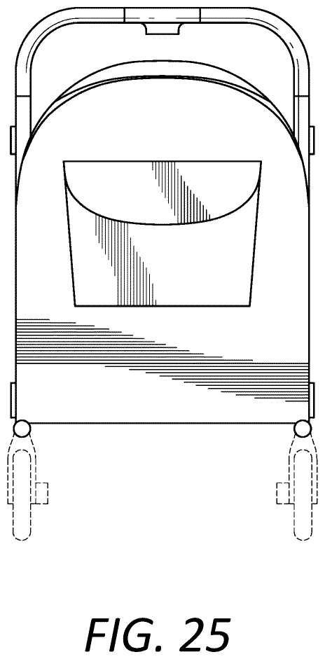

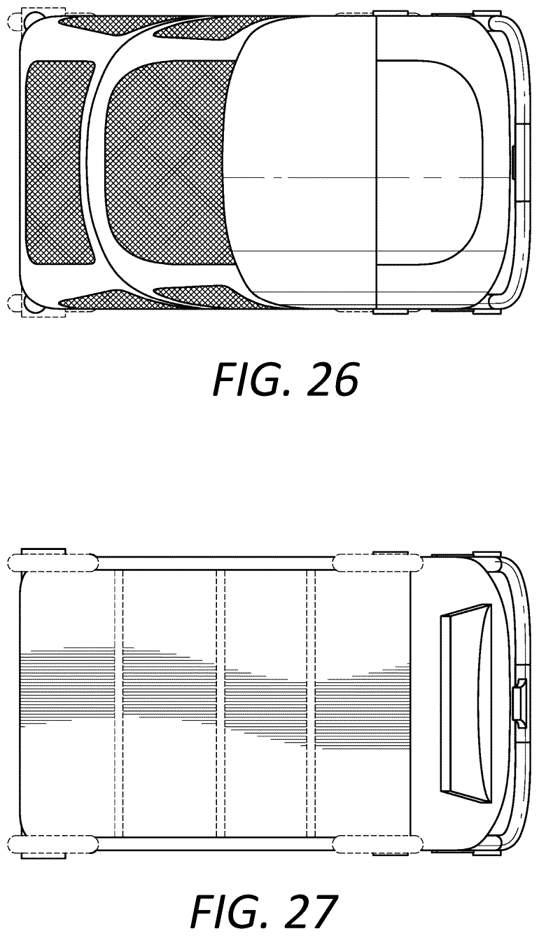

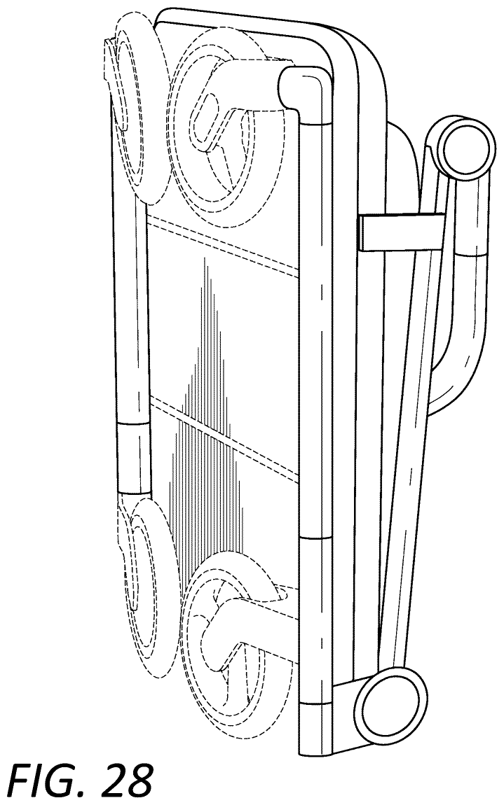

FIG. 21 is a top perspective view showing the front, right, and rear sides of a second pet stroller or foldable vehicle embodiment (four panel) according to the present design. FIG. 22 is a right side elevation view of the second embodiment, FIG. 23 a left side elevation view of the second embodiment, FIG. 24 a front elevation view of the second embodiment, and FIG. 25 a rear elevation view of the second embodiment. FIG. 26 is a top plan view of the second embodiment and FIG. 27 is a bottom plan view of the second embodiment. FIG. 28 presents a perspective drawing of the first and second embodiments of the design in a folded configuration.

The above embodiments are only for illustrating the technical concept and features of the design. The purpose is to enable people familiar with this technology to understand the content of the design and implement it accordingly, and it cannot be used to limit the protection scope of the design or claims. Any equivalent changes or modifications made according to the spirit and essence of the present design are included in the protection scope of the present design and claims.

Thus according to one embodiment, there is provided a foldable vehicle or stroller is provided. The apparatus includes a bottom bracket forming a vehicle base, a push rod bracket rotatably connected to the bottom bracket, and a protective assembly located on one side of the push rod bracket between the push rod bracket and the bottom bracket. The foldable vehicle is in an unfolded state, remote ends of the push rod bracket and the bottom bracket are positioned apart, proximal ends of the push rod bracket and the bottom bracket join at a rotation element, and an accommodating space is formed between the bottom bracket, the protective assembly and the push rod bracket. When the foldable vehicle is in a folded state, remote ends of the push rod bracket and the bottom bracket are positioned proximally and the protective assembly is positioned at least partially between the push rod bracket and the bottom bracket.

According to another embodiment, there is provided a foldable vehicle comprising a vehicle base attached to a set of wheels, a push rod assembly rotatably connected to the vehicle base, and a protective assembly positioned proximate to and between the push rod assembly and the vehicle base. When the foldable vehicle is in an unfolded state, remote ends of the vehicle base and the push rod assembly are positioned apart, proximal ends of the vehicle base and the push rod assembly join at a rotation element, and an accommodating space is formed between the vehicle base, the push rod assembly connected to the vehicle base, and the protective assembly.

According to a further embodiment, there is provided a foldable vehicle comprising a vehicle base attached to a set of wheels, a push rod assembly rotatably connected to the vehicle base, and a protective covering assembly connected to the vehicle base and the push rod assembly. When the foldable vehicle is in an unfolded state, remote ends of the vehicle base and the push rod assembly are positioned apart, proximal ends of the vehicle base and the push rod assembly join at a rotation element, and an accommodating space is formed between the vehicle base, the push rod assembly, and the protective covering assembly.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A foldable vehicle comprising:
a bottom bracket forming a vehicle base;
a push rod bracket rotatably connected to the bottom bracket; and
a protective assembly located on one side of the push rod bracket between the push rod bracket and the bottom bracket;
wherein when the foldable vehicle is in an unfolded state, remote ends of the push rod bracket and the bottom bracket are positioned apart, proximal ends of the push rod bracket and the bottom bracket join at a rotation element, and an accommodating space is formed between the bottom bracket, the protective assembly and the push rod bracket;
wherein when the foldable vehicle is in a folded state, remote ends of the push rod bracket and the bottom bracket are positioned proximally and the protective assembly is positioned at least partially between the push rod bracket and the bottom bracket.

2. The foldable vehicle according to claim 1, wherein the protective assembly comprises a support frame and a first protective member, the support frame is arranged between the push rod bracket and the bottom bracket, the support frame is rotatably connected to the push rod frame, or the bottom bracket, and the first protective member is sleeved on the support frame.

3. The foldable vehicle according to claim 2, wherein the first protective member comprises:
a first opening providing access to the accommodation space; and
a sealing structure configured to control opening and closing of the first opening.

4. The foldable vehicle according to claim 3, characterized in that: the sealing structure comprises one of a nylon buckle, a strap, a button and a zipper assembly.

5. The foldable vehicle according to claim 2 wherein the protective component comprises a flexible cover and arranged on the first protective member and the flexible cover covers at least a portion of an outer surface of the first protective member.

6. The foldable vehicle according to claim 2, further comprising a second protective member fixedly mounted on the push rod frame and is fixedly connected to the first protective member and comprises a second opening connected to the accommodating space.

7. The foldable vehicle according to claim 1, wherein the push rod frame comprises:
a first push rod frame; and
a second push rod frame;
wherein one end of the second push rod frame is rotatably connected to the bottom bracket around a first rotation center line, and a second end of the second push rod frame is rotatably connected to the first push rod frame around a second rotation center line.

8. The foldable vehicle according to claim 1, further comprising a wheel assembly comprising:
a wheel frame; and
a wheel body rotatably connected to the wheel frame around a wheel axle;
wherein the wheel frame is rotatably connected to the bottom bracket around a rotation centerline extending in a first direction;
wherein when the foldable vehicle is in an unfolded state, the wheel axle extends in a horizontal direction and when the foldable vehicle is in a folded state the wheel body is folded adjacent the bottom bracket and the wheel axle extends in a vertical direction.

9. The foldable vehicle according to claim 8, wherein:
the bottom bracket comprises a bottom support rod extending in the first direction;
the wheel frame comprises a connecting rod extending in the first direction;
the bottom support rod comprises a hollow rod cavity extending in the first direction;
the connecting rod is positioned with in the hollow rod cavity; and
the connecting rod has a connecting rod axis extending colinearly with the rotation centerline.

10. A foldable vehicle comprising:
a vehicle base attached to a set of wheels;
a push rod assembly rotatably connected to the vehicle base; and
a protective assembly positioned proximate to and between the push rod assembly and the vehicle base;
wherein when the foldable vehicle is in an unfolded state, remote ends of the vehicle base and the push rod assembly are positioned apart, proximal ends of the vehicle base and the push rod assembly join at a rotation element, and an accommodating space is formed between the vehicle base, the push rod assembly connected to the vehicle base, and the protective assembly.

11. The foldable vehicle according to claim 10, wherein when the foldable vehicle is in a folded state, remote ends of the vehicle base and the push rod assembly are positioned proximally and the protective assembly is positioned at least partially between the vehicle base and the push rod assembly.

12. The foldable vehicle according to claim 10, further comprising a protective component comprising a flexible cover configured to cover at least a portion of an outer surface of the protective assembly.

13. The foldable vehicle according to claim 10, further comprising a wheel assembly comprising:
a wheel frame; and
a wheel body rotatably connected to the wheel frame around a wheel axle;
wherein the wheel frame is rotatably connected to the vehicle base around a rotation centerline extending in a first direction;
wherein when the foldable vehicle is in an unfolded state, the wheel axle extends in a horizontal direction and when the foldable vehicle is in a folded state the wheel body is folded adjacent the vehicle base.

14. The vehicle according to claim 13, wherein:
the vehicle base comprises a bottom support rod extending in the first direction;
the wheel frame comprises a connecting rod extending in the first direction;
the bottom support rod comprises a hollow rod cavity extending in the first direction;
the connecting rod is positioned with in the hollow rod cavity; and
the connecting rod has a connecting rod axis extending colinearly with the rotation centerline.

15. A foldable vehicle comprising:
a vehicle base attached to a set of wheels;
a push rod assembly rotatably connected to the vehicle base; and
a protective covering assembly connected to the vehicle base and the push rod assembly;
wherein when the foldable vehicle is in an unfolded state, remote ends of the vehicle base and the push rod assembly are positioned apart, proximal ends of the vehicle base and the push rod assembly join at a rotation element, and an accommodating space is formed between the vehicle base, the push rod assembly, and the protective covering assembly.

16. The foldable vehicle according to claim 15, wherein when the foldable vehicle is in a folded state, remote ends of the vehicle base and the push rod assembly are positioned proximally and the protective covering assembly is positioned at least partially between the vehicle base and the push rod assembly.

17. The foldable vehicle according to claim 15, further comprising a protective component comprising a flexible top layer configured to cover at least a portion of an outer surface of the protective covering assembly.

18. The foldable vehicle according to claim 15, further comprising a wheel assembly attached to the vehicle base, comprising:
a wheel frame; and
a wheel body rotatably connected to the wheel frame around a wheel axle;
wherein the wheel frame is rotatably connected to the vehicle base around a rotation centerline extending in a first direction.

19. The foldable vehicle according to claim 18, wherein when the foldable vehicle is in an unfolded state, the wheel axle extends in a horizontal direction and when the foldable vehicle is in a folded state the wheel body is folded adjacent the vehicle base.

20. The vehicle according to claim 13, wherein:
the vehicle base comprises a bottom support rod extending in the first direction;
the wheel frame comprises a connecting rod extending in the first direction;
the bottom support rod comprises a hollow rod cavity extending in the first direction;
the connecting rod is positioned with in the hollow rod cavity; and
the connecting rod has a connecting rod axis extending colinearly with the rotation centerline.
